(19) United States
(12) Patent Application Publication
(10) Pub. No.: US 2022/0032102 A1
(43) Pub. Date: Feb. 3, 2022

(54) COMPOSITIONS COMPRISING 1,2-DICHLORO-1,2-DIFLUOROETHYLENE FOR USE IN FIRE SUPPRESSION APPLICATIONS

(71) Applicant: THE CHEMOURS COMPANY FC, LLC, WILMINGTON, DE (US)

(72) Inventors: LUKE DAVID SIMONI, WILMINGTON, DE (US); MARK L ROBIN, MIDDLETOWN, DE (US); BARBARA HAVILAND MINOR, THE VILLAGES, FL (US); VIACHESLAV A PETROV, HOCKESSIN, DE (US)

(73) Assignee: THE CHEMOURS COMPANY FC, LLC, WILMINGTON, DE (US)

(21) Appl. No.: 17/278,745

(22) PCT Filed: Oct. 3, 2019
(86) PCT No.: PCT/US2019/054407

§ 371 Date: Mar. 23, 2021

Related U.S. Application Data
(60) Provisional application No. 62/742,125, filed on Oct. 5, 2018.

(51) Int. Cl. A62D 1/00

(52) U.S. Cl. CPC A62D 1/0057

(57) ABSTRACT

The present application provides compositions comprising 1,2-dichloro-1,2 -difluoroethylene (i.e., CFO-1112) and an additional component. The present application further provides use of the compositions provided herein in fire suppression applications (e.g., total flooding and/or streaming fire suppression applications).

### CROSS-REFERENCE TO RELATED APPLICATIONS

This application claims the benefit of U.S. Provisional Application Ser. No. 62/742,125, filed Oct. 5, 2018, the disclosure of which is incorporated herein by reference in its entirety.

### TECHNICAL FIELD

The present application provides compositions comprising 1,2-dichloro-1,2-difluoroethylene (i.e., CFO-1112) and an additional component. The compositions described herein may be useful, for example, in fire suppression applications (e.g., total flooding and/or streaming fire suppression applications).

### BACKGROUND

Numerous agents and methods of firefighting are known and can be selected for a particular fire, depending upon factors such as its size, location and the type of combustible materials involved. Halogenated hydrocarbon firefighting agents have traditionally been utilized in the fire protection industry, in applications including fire prevention applications, which leave a breathable atmosphere in an enclosed area, total flooding applications, wherein an enclosure is completely filled (i.e., “flooded”) with an effective amount of the agent (e.g., computer rooms, storage vaults, telecommunications switching gear rooms, libraries, document archives, petroleum pipeline pumping stations, and the like), or in streaming applications wherein the agent is directed towards the location of the fire (e.g., commercial hand-held extinguishers). Such extinguishing agents are not only effective but, unlike water, also function as “clean extinguishing agents”, causing little, if any, damage to the enclosure or its contents.

### SUMMARY

The present application provides, inter alia, processes for extinguishing or suppressing a flame, comprising dispensing at the flame a composition comprising:
i) 1,2-dichloro-1,2-difluoroethylene; and
ii) a compound selected from R-1336mzzZ, R-1336mzzE, R-1233xfB, R-1438mzzE, R-1438mzzZ, R-1224ydZ, R-1224ydE, R-1336yf, R-125, R-227ea, R-236fa, R-1225yeE, R-1225yeZ, 1,1,1,2,2,4,5,5,5-nonafluoro-4-(trifluoromethyl)pentan-3-one, water, carbon dioxide, nitrogen, and argon;
   in a concentration sufficient to extinguish or suppress the flame.

The present application further provides methods of reducing the flammability of a fluid, comprising contacting the fluid with a composition comprising:
i) 1,2-dichloro-1,2-difluoroethylene; and
ii) a compound selected from R-1336mzzZ, R-1336mzzE, R-1233xfB, R-1438mzzE, R-1438mzzZ, R-1224ydZ, R-1224ydE, R-1336yf, R-125, R-227ea, R-236fa, R-1225yeE, R-1225yeZ, 1,1,1,2,2,4,5,5,5-nonafluoro-4-(trifluoromethyl)pentan-3-one, water, carbon dioxide, nitrogen, and argon;
   in a concentration sufficient to reduce the flammability of the fluid.

The present application further provides methods of extinguishing or suppressing a fire, comprising:
(a) providing a composition comprising:
   i) 1,2-dichloro-1,2-difluoroethylene; and
   ii) a compound selected from R-1336mzzZ, R-1336mzzE, R-1233xfB, R-1438mzzE, R-1438mzzZ, R-1224ydZ, R-1224ydE, R-1336yf, R-125, R-227ea, R-236fa, R-1225yeE, R-1225yeZ, 1,1,1,2,2,4,5,5,5-nonafluoro-4-(trifluoromethyl)pentan-3-one, water, carbon dioxide, nitrogen, and argon;
(b) disposing the composition in a pressurized discharge system; and
(c) discharging the composition into an area to extinguish or suppress the fire in that area.

The present application further provides methods of inerting an area to reduce or prevent occurrence of a fire, explosion, or combination thereof, in the area, the method comprising:
(a) providing a composition comprising:
   i) 1,2-dichloro-1,2-difluoroethylene; and
   ii) a compound selected from R-1336mzzZ, R-1336mzzE, R-1233xfB, R-1438mzzE, R-1438mzzZ, R-1224ydZ, R-1224ydE, R-1336yf, R-125, R-227ea, R-236fa, R-1225yeE, R-1225yeZ, 1,1,1,2,2,4,5,5,5-nonafluoro-4-(trifluoromethyl)pentan-3-one, water, carbon dioxide, nitrogen, and argon;
(b) disposing the composition in a pressurized discharge system; and
(c) discharging the composition into the area to reduce or prevent the fire, explosion, or combination thereof from occurring.

The present application further provides fire suppression apparatuses or systems comprising a composition comprising:
i) 1,2-dichloro-1,2-difluoroethylene; and
ii) compound selected from R-1336mzzZ, R-1336mzzE, R-1233xfB, R-1438mzzE, R-1438mzzZ, R-1224ydZ, R-1224ydE, R-1336yf, R-125, R-227ea, R-236fa, R-1225yeE, R-1225yeZ, 1,1,1,2,2,4,5,5,5-nonafluoro-4-(trifluoromethyl)pentan-3-one, water, carbon dioxide, nitrogen, and argon;

The present application further provides compositions, comprising:
i) 1,2-dichloro-1,2-difluoroethylene; and
ii) a compound selected from R-1233xfB, R-1438mzzE, R-227ea, R-236fa, R-1225yeE, 1,1,1,2,2,4,5,5,5-nonafluoro-4-(trifluoromethyl)pentan-3-one, carbon dioxide, nitrogen, and argon.

The details of one or more embodiments of the invention are set forth in the accompanying drawings and the description below. Other features, objects, and advantages of the invention will be apparent from the description and drawings, and from the claims.

### DETAILED DESCRIPTION

The present disclosure provides compositions comprising 1,2-dichloro-1,2-difluoroethylene and one or more additional component, which may be useful in one or more of the fire suppression applications as described herein.

### Definitions and Abbreviations

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

As used herein, the term “consisting essentially of” is used to define a composition, method that includes materials, steps, features, components, or elements, in addition to those literally disclosed provided that these additional included materials, steps, features, components, or elements do not materially affect the basic and novel characteristic(s) of the claimed invention, especially the mode of action to achieve the desired result of any of the processes of the present invention. The term “consists essentially of” or “consisting essentially of” occupies a middle ground between “comprising” and “consisting of”.

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

As used herein, the term “about” is meant to account for variations due to experimental error (e.g., plus or minus approximately 10% of the indicated value). All measurements reported herein are understood to be modified by the term “about”, whether or not the term is explicitly used, unless explicitly stated otherwise.

When an amount, concentration, or other value or parameter is given as either a range, preferred range or a list of upper preferable values and/or lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

### Chemicals, Abbreviations, and Acronyms

CFO-1112: 1,2-dichloro-1,2-difluoroethylene (mixture of isomers)

CFO-1112(E) or CFO-1112E: E-1,2-dichloro-1,2-difluoroethylene

CFO-1112(Z) or CFO-1112Z: Z-1,2-dichloro-1,2-difluoroethylene

R-125: pentafluoroethane

R-227ea: 1,1,1,2,3,3,3-heptafluoropropane

R-236fa: 1,1,1,3,3,3-hexafluoropropane

R-1224yd: 1-chloro-2,3,3,3-tetrafluoropropene

R-1224ydZ: (Z)-1-chloro-2,3,3,3-tetrafluoropropene

R-1224ydE: (E)-1-chloro-2,3,3,3-tetrafluoropropene

R-1225: 1,2,3,3,3-pentafluoroprop-1-ene

R-1225yeE: (E)-1,2,3,3,3-pentafluoroprop-1-ene

R-1225yeZ: (Z)-1,2,3,3,3-pentafluoroprop-1-ene

R-1233xfB: 2-bromo-3,3,3-trifluoroprop-1-ene

R-1336mzz or HFO-1336mzz: 1,1,1,4,4,4-hexafluorobut-2-ene (mixture of isomers)

R-1336mzzZ or HFO-1336mzz(Z) or (Z)-1336mzz: (Z)-1,1,1,4,4,4-hexafluorobut-2-ene

R-1336mzzE or HFO-1336mzz(E) or (E)-1336mzz: (E)-1,1,1,4,4,4-hexafluorobut-2-ene

R-1336yf: 2,3,3,4,4,4-hexafluorobut-1-ene (mixture of isomers)

R-1438mzz: 1,1,1,4,4,5,5,5-octafluoropent-2-ene

R-1438mzzE or HFO-1438mzz(E): (E)-1,1,1,4,4,5,5,5-octafluoropent-2-ene

R-1438mzzZ or HFO-1438mzz(Z): (Z)-1,1,1,4,4,5,5,5-octafluoropent-2-ene

### Compositions

In some embodiments, the present application provides a composition comprising:
i) 1,2-dichloro-1,2-difluoroethylene; and, optionally,
ii) a compound selected from R-1336mzzZ, R-1336mzzZ, R-1233xfB, R-1438mzzE, R-1438mzzZ, R-1224ydZ, R-1224ydE, R-1336yf, R-125, R-227ea, R-236fa, R-1225yeE, R-1225yeZ, 1,1,1,2,2,4,5,5,5-nonafluoro-4-(trifluoromethyl)pentan-3-one, water, carbon dioxide, nitrogen, and argon;

In some embodiments, the present application provides a composition comprising:
i) 1,2-dichloro-1,2-difluoroethylene; and
ii) a compound selected from R-1336mzzZ, R-1233xfB, R-1438mzzE, R-1336mzzE, R-1224ydZ, R-1224ydE, R-1336yf, R-125, R-227ea, R-236fa, R-1225yeE, 1,1,1,2,2,4,5,5,5-nonafluoro-4-(trifluoromethyl)pentan-3-one, carbon dioxide, nitrogen, and argon.

In some embodiments, the composition provided herein comprises:
i) 1,2-dichloro-1,2-difluoroethylene; and
ii) a compound selected from R-1233xfB, R-1438mzzE, R-227ea, R-236fa, R-1225yeE, 1,1,1,2,2,4,5,5,5-nonafluoro-4-(trifluoromethyl)pentan-3-one, carbon dioxide, nitrogen, and argon.

In some embodiments, the 1,2-dichloro-1,2-difluoroethylene comprises a mixture of (E)-1,2-dichloro-1,2-difluoroethylene and (Z)-1,2-dichloro-1,2-difluoroethylene.

In some embodiments, the 1,2-dichloro-1,2-difluoroethylene comprises about 60% to about 70% E-1,2-dichloro-1,2-difluoroethylene and about 30% to about 40% Z-1,2-dichloro-1,2-difluoroethylene.

In some embodiments, the 1,2-dichloro-1,2-difluoroethylene comprises about 60% E-1,2-dichloro-1,2-difluoroethylene and about 40% Z-1,2-dichloro-1,2-difluoroethylene. In some embodiments, the 1,2-dichloro-1,2-difluoroethylene comprises about 70% E-1,2-dichloro-1,2-difluoroethylene and about 30% Z-1,2-dichloro-1,2-difluoroethylene.

In some embodiments, the composition provided herein comprises about 1 to about 99 weight percent 1,2-dichloro-1,2-difluoroethylene and about 99 to about 1 weight percent of a compound selected from R-1336mzzZ, R-1336mzzE, R-1233xfB, R-1438mzzE, R-1438mzzZ, R-1224ydZ, R-1224ydE, R-1336yf, R-125, R-227ea, R-236fa, R-1225yeE, R-1225yeZ, 1,1,1,2,2,4,5,5,5-nonafluoro-4-(trifluoromethyl)pentan-3-one, water, carbon dioxide, nitrogen, and argon.

In some embodiments, the composition provided herein comprises about 1 to about 20 weight percent 1,2-dichloro-1,2-difluoroethylene and about 99 to about 80 weight percent of a compound selected from R-1336mzzZ, R-1336mzzE, R-1233xfB, R-1438mzzE, R-1438mzzZ, R-1224ydZ, R-1224ydE, R-1336yf, R-125, R-227ea, R-236fa, R-1225yeE, R-1225yeZ, 1,1,1,2,2,4,5,5,5-nonafluoro-4-(trifluoromethyl)pentan-3-one, water, carbon dioxide, nitrogen, and argon.

In some embodiments, the composition provided herein comprises about 1 to about 12 weight percent 1,2-dichloro-1,2-difluoroethylene and about 99 to about 88 weight percent of a compound selected from R-1336mzzZ, R-1336mzzE, R-1233xfB, R-1438mzzE, R-1438mzzZ, R-1224ydZ, R-1224ydE, R-1336yf, R-125, R-227ea, R-236fa, R-1225yeE, R-1225yeZ, 1,1,1,2,2,4,5,5,5-nonafluoro-4-(trifluoromethyl)pentan-3-one, water, carbon dioxide, nitrogen, and argon.

In some embodiments, the composition provided herein comprises about 1 to about 5 weight percent 1,2-dichloro-1,2-difluoroethylene and about 99 to about 95 weight percent of a compound selected from R-1336mzzZ, R-1336mzzE, R-1233xfB, R-1438mzzE, R-1438mzzZ, R-1224ydZ, R-1224ydE, R-1336yf, R-125, R-227ea, R-236fa, R-1225yeE, R-1225yeZ, 1,1,1,2,2,4,5,5,5-nonafluoro-4-(trifluoromethyl)pentan-3-one, water, carbon dioxide, nitrogen, and argon.

In some embodiments, the composition comprises 1,2-dichloro-1,2-difluoroethylene and R-1336mzzZ. In some embodiments, the composition provided herein comprises about 1 to about 99 weight percent 1,2-dichloro-1,2-difluoroethylene and about 99 to about 1 weight percent R-1336mzzZ. In some embodiments, the composition provided herein comprises about 1 to about 20 weight percent 1,2-dichloro-1,2-difluoroethylene and about 99 to about 80 weight percent R-1336mzzZ. In some embodiments, the composition provided herein comprises about 1 to about 12 weight percent 1,2-dichloro-1,2-difluoroethylene and about 99 to about 88 weight percent R-1336mzzZ. In some embodiments, the composition provided herein comprises about 1 to about 5 weight percent 1,2-dichloro-1,2-difluoroethylene and about 99 to about 95 weight percent R-1336mzzZ. In some embodiments, the composition consists essentially of 1,2-dichloro-1,2-difluoroethylene and R-1336mzzZ. In some embodiments, the composition consists of 1,2-dichloro-1,2-difluoroethylene and R-1336mzzZ.

In some embodiments, the composition comprises 1,2-dichloro-1,2-difluoroethylene and R-1336mzzE. In some embodiments, the composition provided herein comprises about 1 to about 99 weight percent 1,2-dichloro-1,2-difluoroethylene and about 99 to about 1 weight percent R-1336mzzE. In some embodiments, the composition provided herein comprises about 1 to about 20 weight percent 1,2-dichloro-1,2-difluoroethylene and about 99 to about 80 weight percent R-1336mzzE. In some embodiments, the composition provided herein comprises about 1 to about 12 weight percent 1,2-dichloro-1,2-difluoroethylene and about 99 to about 88 weight percent R-1336mzzE. In some embodiments, the composition provided herein comprises about 1 to about 5 weight percent 1,2-dichloro-1,2-difluoroethylene and about 99 to about 95 weight percent R-1336mzzE. In some embodiments, the composition consists essentially of 1,2-dichloro-1,2-difluoroethylene and R-1336mzzE. In some embodiments, the composition consists of 1,2-dichloro-1,2-difluoroethylene and R-1336mzzE.

In some embodiments, the composition comprises 1,2-dichloro-1,2-difluoroethylene and R-1233xfB. In some embodiments, the composition provided herein comprises about 1 to about 99 weight percent 1,2-dichloro-1,2-difluoroethylene and about 99 to about 1 weight percent R-1233xfB. In some embodiments, the composition provided herein comprises about 1 to about 20 weight percent 1,2-dichloro-1,2-difluoroethylene and about 99 to about 80 weight percent R-1233xfB. In some embodiments, the composition provided herein comprises about 1 to about 12 weight percent 1,2-dichloro-1,2-difluoroethylene and about 99 to about 88 weight percent R-1233xfB. In some embodiments, the composition provided herein comprises about 1 to about 5 weight percent 1,2-dichloro-1,2-difluoroethylene and about 99 to about 95 weight percent R-1233xfB. In some embodiments, the composition consists essentially of 1,2-dichloro-1,2-difluoroethylene and R-1233xfB. In some embodiments, the composition consists of 1,2-dichloro-1,2-difluoroethylene and R-1233xfB.

In some embodiments, the composition comprises 1,2-dichloro-1,2-difluoroethylene and R-1438mzzE. In some embodiments, the composition provided herein comprises about 1 to about 99 weight percent 1,2-dichloro-1,2-difluoroethylene and about 99 to about 1 weight percent R-1438mzzE. In some embodiments, the composition provided herein comprises about 1 to about 20 weight percent 1,2-dichloro-1,2-difluoroethylene and about 99 to about 80 weight percent R-1438mzzE. In some embodiments, the composition provided herein comprises about 1 to about 12 weight percent 1,2-dichloro-1,2-difluoroethylene and about 99 to about 88 weight percent R-1438mzzE. In some embodiments, the composition provided herein comprises about 1 to about 5 weight percent 1,2-dichloro-1,2-difluoroethylene and about 99 to about 95 weight percent R-1438mzzE. In some embodiments, the composition consists essentially of 1,2-dichloro-1,2-difluoroethylene and R-1438mzzE. In some embodiments, the composition consists of 1,2-dichloro-1,2-difluoroethylene and R-1438mzzE.

In some embodiments, the composition comprises 1,2-dichloro-1,2-difluoroethylene and R-1438mzzZ. In some embodiments, the composition provided herein comprises about 1 to about 99 weight percent 1,2-dichloro-1,2-difluoroethylene and about 99 to about 1 weight percent R-1438mzzZ. In some embodiments, the composition provided herein comprises about 1 to about 20 weight percent 1,2-dichloro-1,2-difluoroethylene and about 99 to about 80 weight percent R-1438mzzZ. In some embodiments, the composition provided herein comprises about 1 to about 12 weight percent 1,2-dichloro-1,2-difluoroethylene and about 99 to about 88 weight percent R-1438mzzZ. In some embodiments, the composition provided herein comprises about 1 to about 5 weight percent 1,2-dichloro-1,2-difluoroethylene and about 99 to about 95 weight percent R-1438mzzZ. In some embodiments, the composition consists essentially of 1,2-dichloro-1,2-difluoroethylene and R-1438mzzZ. In some embodiments, the composition consists of 1,2-dichloro-1,2-difluoroethylene and R-1438mzzZ.

In some embodiments, the composition comprises 1,2-dichloro-1,2-difluoroethylene and R-1224ydZ. In some embodiments, the composition provided herein comprises about 1 to about 99 weight percent 1,2-dichloro-1,2-difluoroethylene and about 99 to about 1 weight percent R-1224ydZ. In some embodiments, the composition provided herein comprises about 1 to about 20 weight percent 1,2-dichloro-1,2-difluoroethylene and about 99 to about 80 weight percent R-1224ydZ. In some embodiments, the composition provided herein comprises about 1 to about 12 weight percent 1,2-dichloro-1,2-difluoroethylene and about 99 to about 88 weight percent R-1224ydZ. In some embodiments, the composition provided herein comprises about 1 to about 5 weight percent 1,2-dichloro-1,2-difluoroethylene and about 99 to about 95 weight percent R-1224ydZ. In some embodiments, the composition consists essentially of 1,2-dichloro-1,2-difluoroethylene and R-1224ydZ. In some embodiments, the composition consists of 1,2-dichloro-1,2-difluoroethylene and R-1224ydZ.

In some embodiments, the composition comprises 1,2-dichloro-1,2-difluoroethylene and R-1224ydE. In some embodiments, the composition provided herein comprises about 1 to about 99 weight percent 1,2-dichloro-1,2-difluoroethylene and about 99 to about 1 weight percent R-1224ydE. In some embodiments, the composition provided herein comprises about 1 to about 20 weight percent 1,2-dichloro-1,2-difluoroethylene and about 99 to about 80 weight percent R-1224ydE. In some embodiments, the composition provided herein comprises about 1 to about 12 weight percent 1,2-dichloro-1,2-difluoroethylene and about 99 to about 88 weight percent R-1224ydE. In some embodiments, the composition provided herein comprises about 1 to about 5 weight percent 1,2-dichloro-1,2-difluoroethylene and about 99 to about 95 weight percent R-1224ydE. In some embodiments, the composition consists essentially of 1,2-dichloro-1,2-difluoroethylene and R-1224ydE. In some embodiments, the composition consists of 1,2-dichloro-1,2-difluoroethylene and R-1224ydE.

In some embodiments, the composition comprises 1,2-dichloro-1,2-difluoroethylene and R-1336yf. In some embodiments, the composition provided herein comprises about 1 to about 99 weight percent 1,2-dichloro-1,2-difluoroethylene and about 99 to about 1 weight percent R-1336yf. In some embodiments, the composition provided herein comprises about 1 to about 20 weight percent 1,2-dichloro-1,2-difluoroethylene and about 99 to about 80 weight percent R-1336yf. In some embodiments, the composition provided herein comprises about 1 to about 12 weight percent 1,2-dichloro-1,2-difluoroethylene and about 99 to about 88 weight percent R-1336yf. In some embodiments, the composition provided herein comprises about 1 to about 5 weight percent 1,2-dichloro-1,2-difluoroethylene and about 99 to about 95 weight percent R-1336yf. In some embodiments, the composition consists essentially of 1,2-dichloro-1,2-difluoroethylene and R-1336yf. In some embodiments, the composition consists of 1,2-dichloro-1,2-difluoroethylene and R-1336yf.

In some embodiments, the composition comprises 1,2-dichloro-1,2-difluoroethylene and R-125. In some embodiments, the composition provided herein comprises about 1 to about 99 weight percent 1,2-dichloro-1,2-difluoroethylene and about 99 to about 1 weight percent R-125. In some embodiments, the composition provided herein comprises about 1 to about 20 weight percent 1,2-dichloro-1,2-difluoroethylene and about 99 to about 80 weight percent R-125. In some embodiments, the composition provided herein comprises about 1 to about 12 weight percent 1,2-dichloro-1,2-difluoroethylene and about 99 to about 88 weight percent R-125. In some embodiments, the composition provided herein comprises about 1 to about 5 weight percent 1,2-dichloro-1,2-difluoroethylene and about 99 to about 95 weight percent R-125. In some embodiments, the composition consists essentially of 1,2-dichloro-1,2-difluoroethylene and R-125. In some embodiments, the composition consists of 1,2-dichloro-1,2-difluoroethylene and R-125.

In some embodiments, the composition comprises 1,2-dichloro-1,2-difluoroethylene and R-227ea. In some embodiments, the composition provided herein comprises about 1 to about 99 weight percent 1,2-dichloro-1,2-difluoroethylene and about 99 to about 1 weight percent R-227ea. In some embodiments, the composition provided herein comprises about 1 to about 20 weight percent 1,2-dichloro-1,2-difluoroethylene and about 99 to about 80 weight percent R-227ea. In some embodiments, the composition provided herein comprises about 1 to about 12 weight percent 1,2-dichloro-1,2-difluoroethylene and about 99 to about 88 weight percent R-227ea. In some embodiments, the composition provided herein comprises about 1 to about 5 weight percent 1,2-dichloro-1,2-difluoroethylene and about 99 to about 95 weight percent R-227ea. In some embodiments, the composition consists essentially of 1,2-dichloro-1,2-difluoroethylene and R-227ea. In some embodiments, the composition consists of 1,2-dichloro-1,2-difluoroethylene and R-227ea.

In some embodiments, the composition comprises 1,2-dichloro-1,2-difluoroethylene and 1,1,1,2,2,4,5,5,5-nonafluoro-4-(trifluoromethyl)pentan-3-one. In some embodiments, the composition provided herein comprises about 1 to about 99 weight percent 1,2-dichloro-1,2-difluoroethylene and about 99 to about 1 weight percent 1,1,1,2,2,4,5,5,5-nonafluoro-4-(trifluoromethyl)pentan-3-one. In some embodiments, the composition provided herein comprises about 1 to about 20 weight percent 1,2-dichloro-1,2-difluoroethylene and about 99 to about 80 weight percent 1,1,1,2,2,4,5,5,5-nonafluoro-4-(trifluoromethyl)pentan-3-one. In some embodiments, the composition provided herein comprises about 1 to about 12 weight percent 1,2-dichloro-1,2-difluoroethylene and about 99 to about 88 weight percent 1,1,1,2,2,4,5,5,5-nonafluoro-4-(trifluoromethyl)pentan-3-one. In some embodiments, the composition provided herein comprises about 1 to about 5 weight percent 1,2-dichloro-1,2-difluoroethylene and about 99 to about 95 weight percent 1,1,1,2,2,4,5,5,5-nonafluoro-4-(trifluoromethyl)pentan-3-one. In some embodiments, the composition consists essentially of 1,2-dichloro-1,2-difluoroethylene and 1,1,1,2,2,4,5,5,5-nonafluoro-4-(trifluoromethyl)pentan-3-one. In some embodiments, the composition consists of 1,2-dichloro-1,2-difluoroethylene and 1,1,1,2,2,4,5,5,5-nonafluoro-4-(trifluoromethyl)pentan-3 -one.

In some embodiments, the composition comprises 1,2-dichloro-1,2-difluoroethylene and carbon dioxide. In some embodiments, the composition provided herein comprises about 1 to about 99 weight percent 1,2-dichloro-1,2-difluoroethylene and about 99 to about 1 weight percent carbon dioxide. In some embodiments, the composition provided herein comprises about 1 to about 20 weight percent 1,2-dichloro-1,2-difluoroethylene and about 99 to about 80 weight percent carbon dioxide. In some embodiments, the composition provided herein comprises about 1 to about 12 weight percent 1,2-dichloro-1,2-difluoroethylene and about 99 to about 88 weight percent carbon dioxide. In some embodiments, the composition provided herein comprises about 1 to about 5 weight percent 1,2-dichloro-1,2-difluoroethylene and about 99 to about 95 weight percent carbon dioxide. In some embodiments, the composition consists essentially of 1,2-dichloro-1,2-difluoroethylene and carbon dioxide. In some embodiments, the composition consists of 1,2-dichloro-1,2-difluoroethylene and carbon dioxide.

In some embodiments, the composition comprises 1,2-dichloro-1,2-difluoroethylene and water. In some embodiments, the composition provided herein comprises about 1 to about 99 weight percent 1,2-dichloro-1,2-difluoroethylene and about 99 to about 1 weight percent water. In some embodiments, the composition provided herein comprises about 1 to about 20 weight percent 1,2-dichloro-1,2-difluoroethylene and about 99 to about 80 weight percent water. In some embodiments, the composition provided herein comprises about 1 to about 12 weight percent 1,2-dichloro-1,2-difluoroethylene and about 99 to about 88 weight percent water. In some embodiments, the composition provided herein comprises about 1 to about 5 weight percent 1,2-dichloro-1,2-difluoroethylene and about 99 to about 95 weight percent water. In some embodiments, the composition consists essentially of 1,2-dichloro-1,2-difluoroethylene and water. In some embodiments, the composition consists of 1,2-dichloro-1,2-difluoroethylene and water.

In some embodiments, the composition comprises 1,2-dichloro-1,2-difluoroethylene and nitrogen. In some embodiments, the composition provided herein comprises about 1 to about 99 weight percent 1,2-dichloro-1,2-difluoroethylene and about 99 to about 1 weight percent nitrogen. In some embodiments, the composition provided herein comprises about 1 to about 20 weight percent 1,2-dichloro-1,2-difluoroethylene and about 99 to about 80 weight percent nitrogen. In some embodiments, the composition provided herein comprises about 1 to about 12 weight percent 1,2-dichloro-1,2-difluoroethylene and about 99 to about 88 weight percent nitrogen. In some embodiments, the composition provided herein comprises about 1 to about 5 weight percent 1,2-dichloro-1,2-difluoroethylene and about 99 to about 95 weight percent nitrogen. In some embodiments, the composition consists essentially of 1,2-dichloro-1,2-difluoroethylene and nitrogen. In some embodiments, the composition consists of 1,2-dichloro-1,2-difluoroethylene and nitrogen.

In some embodiments, the composition comprises 1,2-dichloro-1,2-difluoroethylene and argon. In some embodiments, the composition provided herein comprises about 1 to about 99 weight percent 1,2-dichloro-1,2-difluoroethylene and about 99 to about 1 weight percent argon. In some embodiments, the composition provided herein comprises about 1 to about 20 weight percent 1,2-dichloro-1,2-difluoroethylene and about 99 to about 80 weight percent argon. In some embodiments, the composition provided herein comprises about 1 to about 12 weight percent 1,2-dichloro-1,2-difluoroethylene and about 99 to about 88 weight percent argon. In some embodiments, the composition provided herein comprises about 1 to about 5 weight percent 1,2-dichloro-1,2-difluoroethylene and about 99 to about 95 weight percent argon. In some embodiments, the composition consists essentially of 1,2-dichloro-1,2-difluoroethylene and argon. In some embodiments, the composition consists of 1,2-dichloro-1,2-difluoroethylene and argon.

In some embodiments, the composition comprises 1,2-dichloro-1,2-difluoroethylene and R-236fa. In some embodiments, the composition provided herein comprises about 1 to about 99 weight percent 1,2-dichloro-1,2-difluoroethylene and about 99 to about 1 weight percent R-236fa. In some embodiments, the composition provided herein comprises about 1 to about 20 weight percent 1,2-dichloro-1,2-difluoroethylene and about 99 to about 80 weight percent R-236fa. In some embodiments, the composition provided herein comprises about 1 to about 12 weight percent 1,2-dichloro-1,2-difluoroethylene and about 99 to about 88 weight percent R-236fa. In some embodiments, the composition provided herein comprises about 1 to about 5 weight percent 1,2-dichloro-1,2-difluoroethylene and about 99 to about 95 weight percent R-236fa. In some embodiments, the composition consists essentially of 1,2-dichloro-1,2-difluoroethylene and R-236fa. In some embodiments, the composition consists of 1,2-dichloro-1,2-difluoroethylene and R-236fa.

In some embodiments, the composition comprises 1,2-dichloro-1,2-difluoroethylene and R-1225yeE. In some embodiments, the composition provided herein comprises about 1 to about 99 weight percent 1,2-dichloro-1,2-difluoroethylene and about 99 to about 1 weight percent R-1225yeE. In some embodiments, the composition provided herein comprises about 1 to about 20 weight percent 1,2-dichloro-1,2-difluoroethylene and about 99 to about 80 weight percent R-1225yeE. In some embodiments, the composition provided herein comprises about 1 to about 12 weight percent 1,2-dichloro-1,2-difluoroethylene and about 99 to about 88 weight percent R-1225yeE. In some embodiments, the composition provided herein comprises about 1 to about 5 weight percent 1,2-dichloro-1,2-difluoroethylene and about 99 to about 95 weight percent R-1225yeE. In some embodiments, the composition consists essentially of 1,2-dichloro-1,2-difluoroethylene and R-1225yeE. In some embodiments, the composition consists of 1,2-dichloro-1,2-difluoroethylene and R-1225yeE.

In some embodiments, the composition comprises 1,2-dichloro-1,2-difluoroethylene and R-1225yeZ. In some embodiments, the composition provided herein comprises about 1 to about 99 weight percent 1,2-dichloro-1,2-difluoroethylene and about 99 to about 1 weight percent R-1225yeZ. In some embodiments, the composition provided herein comprises about 1 to about 20 weight percent 1,2-dichloro-1,2-difluoroethylene and about 99 to about 80 weight percent R-1225yeZ. In some embodiments, the composition provided herein comprises about 1 to about 12 weight percent 1,2-dichloro-1,2-difluoroethylene and about 99 to about 88 weight percent R-1225yeZ. In some embodiments, the composition provided herein comprises about 1 to about 5 weight percent 1,2-dichloro-1,2-difluoroethylene and about 99 to about 95 weight percent R-1225yeZ. In some embodiments, the composition consists essentially of 1,2-dichloro-1,2-difluoroethylene and R-1225yeZ. In some embodiments, the composition consists of 1,2-dichloro-1,2-difluoroethylene and R-1225yeZ.

### Methods of Use

The present application further provides processes and methods for extinguishing or suppressing a flame, comprising dispensing at the flame a composition provided herein in a concentration sufficient to extinguish or suppress the flame. Any suitable methods for contacting the flame with the compositions provided herein may be used. For example, the compositions provided herein may be sprayed or poured onto the flame, or at least a portion of the flame may be immersed in the composition. In light of the teachings herein, those of skill in the art will be readily able to adapt a variety of conventional apparatus and methods of flame suppression for use in the present disclosure.

As used here, the term “extinguish” or “extinguishment” is generally used to denote complete elimination of a fire; whereas, “suppression” is often used to denote reduction, but not necessarily total elimination, of a fire or explosion.

The present application includes, but is not limited to, the following four general types of fire and explosion protection applications:
1) In total-flood fire extinguishment and/or suppression applications, the composition provided herein can be discharged into a space to achieve a concentration sufficient to extinguish or suppress an existing fire. Total flooding use includes protection of enclosed, potentially occupied spaces such, as computer rooms as well as specialized, often unoccupied spaces such as aircraft engine nacelles and engine compartments in vehicles.
2) In streaming applications, the composition can be applied directly onto a fire or into the region of a fire. This is usually accomplished using manually operated wheeled or portable units. A second method, included as a streaming application, uses a “localized” system, which discharges the agent toward a fire from one or more fixed nozzles. Localized systems may be activated either manually or automatically.
3) In explosion suppression, the composition can be discharged to suppress an explosion that has already been initiated. The term “suppression” is normally used in this application because the explosion is usually self-limiting. However, the use of this term does not necessarily imply that the explosion is not extinguished by the composition. In this application, a detector is usually used to detect an expanding fireball from an explosion, and the composition can be discharged rapidly to suppress the explosion. Explosion suppression is used primarily, but not solely, in defense applications.
4) In inertion, the composition is discharged into a space to prevent an explosion or a fire from being initiated. Often, a system similar or identical to that used for total-flood fire extinguishment or suppression is used. Usually, the presence of a dangerous condition (e.g., dangerous concentrations of flammable or explosive gases) is detected, and the composition can be discharged to prevent the explosion or fire from occurring until the condition can be remedied.

In some embodiments, the present application provides a method of reducing the flammability of a fluid, comprising contacting the fluid with a composition provided herein in a concentration sufficient to reduce the flammability of the fluid. As used herein, the term “flammability” refers the ability of a composition to ignite and/or propagate a flame.

The present application further provides a method of extinguishing or suppressing a fire, comprising
(a) providing a composition provided herein;
(b) disposing the composition in a pressurized discharge system; and
(c) discharging the composition into an area to extinguish or suppress the fire in that area. In some embodiments, the method provided herein is a total flooding method or a streaming method.

Thus, the compositions provided herein may be useful in a total flooding fire extinguishing system in which the composition is introduced to an enclosed region (e.g., a room or other enclosure) surrounding a fire at a concentration sufficient to extinguish the fire. In accordance with a total flooding system apparatus, equipment or even rooms or enclosures may be provided with a source of the composition and appropriate piping, valves, and controls so as automatically and/or manually to be introduced at appropriate concentrations in the event that fire should break out. Thus, as is known to those skilled in the art, the fire extinguishant may be pressurized with nitrogen or other inert gas at up to about 1200 psig at ambient conditions.

Alternatively, the compositions provided herein may be applied to a fire through the use of conventional portable fire extinguishing equipment. It is usual to increase the pressure in portable fire extinguishers with nitrogen or other inert gases in order to ensure that the agent is completely expelled from the extinguisher. Fire extinguishing systems in accordance with this invention may be conveniently pressurized at any desirable pressure up to about 600 psig at ambient conditions.

The present application further provides methods of inerting a space to prevent a fire or explosion comprising providing a composition provided herein; disposing the composition in a pressurized discharge system; and discharging the composition into the space to prevent a fire or explosion from occurring.

The extinguishing method can be carried out by introducing the composition into an enclosed area surrounding a fire. Any of the known methods of introduction can be utilized provided that appropriate quantities of the composition are metered into the enclosed area at appropriate intervals. For example, a composition can be introduced by streaming, e.g., using conventional portable (or fixed) fire extinguishing equipment; by misting; or by flooding, e.g., by releasing (using appropriate piping, valves, and controls) the composition into an enclosed area surrounding a fire. The composition can optionally be combined with an inert propellant to increase the rate of discharge of the composition from the streaming or flooding equipment utilized.

In some embodiments, the extinguishing process involves introducing a composition provided herein to a fire or flame in an amount sufficient to extinguish the fire or flame. One skilled in this field will recognize that the amount of composition needed to extinguish a particular fire will depend upon the nature and extent of the hazard. When the composition is to be introduced by flooding, cup burner test data are useful in determining the amount or concentration of composition required to extinguish a particular type and size of fire.

Laboratory tests useful for determining effective concentration ranges of a composition when used in conjunction with extinguishing or suppressing a fire in a total-flood application or fire inertion can be found, for example, in U.S. Pat. No. 5,759,430.

It should be understood that fire extinguishing using a “flooding” or “total flooding” method, as provided herein, provides sufficient extinguishing agent(s) to flood an entire enclosure or room in which the fire is detected. Assuming perfect mixing of gases in the enclosure, the composition of the gases, including the extinguishing agent(s), at the burning material, is identical to the composition of gases at any other location within the enclosure. However, clearly, it is the composition of gases at the burning material which governs whether a fire can be extinguished and, since the mixing of gases in the enclosure may not be homogeneous early in the extinguishing process, the appended claims refer to the gas composition “at the burning material”.

The compositions provided herein may be stored, for example, in a conventional fire suppression agent storage cylinder fitted with a dip tube to afford delivery of the agent through a piping system. As it well known and practiced widely throughout the industry, the composition in the cylinder can be superpressurized with nitrogen or another inert gas, typically to levels of 360 or 600 psig. Alternatively, the individual components of the composition provided herein (i.e., the 1,2-dichloro-1,2-difluoroethylene; and the compound selected from R-1336mzzZ, R-1336mzzE, R-1233xfB, R-1438mzzE, R-1438mzzZ, R-1224ydZ, R-1224ydE, R-1336yf, R-125, R-227ea, R-236fa, R-1225yeE, R-1225yeZ, 1,1,1,2,2,4,5,5,5-nonafluoro-4-(trifluoromethyl)pentan-3-one, water, carbon dioxide, nitrogen, and argon) can be stored as pure materials in suitable cylinders to which is connected a pressurization system. The components can be stored as the pure liquefied compressed gas in the storage cylinder under its own equilibrium vapor pressure at ambient temperatures, and upon detection of a fire, the cylinders can be pressurized by suitable means, and once pressurized to the desired level, the components are mixed and the composition is activated. Alternatively, the composition can be stored as a pure material in a suitable cylinder to which is connected a pressurization system as described above. Such a “piston flow” method for delivering a fire suppression agent to an enclosure, and additional fire suppression agents (e.g., perfluorocarbons, hydrochlorofluorocarbons, and the like) useful in accordance with the present invention, have been described in U.S. Pat. No. 6,112,822, the disclosure of which is incorporated herein by reference in its entirety.

In some embodiments, the present application provides methods for extinguishing fires which comprises a system consisting of a composition provided herein stored in a suitable cylinder, or, alternatively, the individual components of a composition provided herein (i.e., the 1,2-dichloro-1,2-difluoroethylene; and the compound selected from R-1336mzzZ, R-1336mzzE, R-1233xfB, R-1438mzzE, R-1438mzzZ, R-1224ydZ, R-1224ydE, R-1336yf, R-125, R-227ea, R-236fa, R-1225yeE, R-1225yeZ, 1,1,1,2,2,4,5,5,5-nonafluoro-4-(trifluoromethyl)pentan-3-one, water, carbon dioxide, nitrogen, and argon), each stored in separate suitable cylinders. When contained in separate cylinders, each cylinder is connected via the appropriate piping and valves to discharge nozzles located within the hazard being protected. Upon detection of a fire, the suppression system is activated. In some embodiments, components are released from their respective storage cylinders simultaneously, affording delivery of the components to the protected hazard at the same time, thereby forming the composition provided herein. Typical detection systems, for example, smoke detectors, infrared detectors, air sampling detectors, and the like, may be employed to activate the system, and a delay between detection and agent delivery may be employed if deemed appropriate to the hazard. In a further embodiment of the invention, upon detection of the fire the 1,2-dichloro-1,2-difluoroethylene is delivered to the enclosure first, and the second component (i.e., R-1336mzzZ, R-1336mzzE, R-1233xfB, R-1438mzzE, R-1438mzzZ, R-1224ydZ, R-1224ydE, R-1336yf, R-125, R-227ea, R-236fa, R-1225yeE, R-1225yeZ, 1,1,1,2,2,4,5,5,5-nonafluoro-4-(trifluoromethyl)pentan-3-one, water, carbon dioxide, nitrogen, or argon) is delivered at a later time, either during or after the 1,2-dichloro-1,2-difluoroethylene discharge, depending upon the needs of the particular fire scenario.

### EXAMPLES

The invention will be described in greater detail by way of specific examples. The following examples are offered for illustrative purposes, and are not intended to limit the invention in any manner. Those of skill in the art will readily recognize a variety of non-critical parameters which can be changed or modified to yield essentially the same results.

### Example 1. Dynamic Extinguishing Experiments

Dynamic extinguishing concentration data for 1,2-dichloro-1,2-difluoroethylene were obtained using the standard cup burner test procedure (Appendix B, NFPA 2001, 2015 Edition), in which air and n-heptane fuel are continuously supplied to a flame produced in a glass cup burner. Vapor of the agent to be tested was then mixed with air and introduced to the flame, with the concentration of agent being slowly increased until the flow was just sufficient to cause extinction of the flame. Agent concentration at extinguishment (the extinguishing concentration) was then determined via GC analysis of a sample taken near the edge of the cup in the cup burner apparatus. The extinguishing concentration for n-heptane fuel was determined to be 8.3% v/v CFO-1112.

### Other Embodiments

1. In some embodiments, the present application provides a method for extinguishing or suppressing a flame, comprising dispensing at the flame a composition comprising:
   i) 1,2-dichloro-1,2-difluoroethylene; and
   ii) a compound selected from R-1336mzzZ, R-1336mzzE, R-1233xfB, R-1438mzzE, R-1438mzzZ, R-1224ydZ, R-1224ydE, R-1336yf, R-125, R-227ea, R-236fa, R-1225yeE, R-1225yeZ, 1,1,1,2,2,4,5,5,5-nonafluoro-4-(trifluoromethyl)pentan-3-one, water, carbon dioxide, nitrogen, and argon;

in a concentration sufficient to extinguish or suppress the flame.
2. In some embodiments, the present application further provides a method of reducing the flammability of a fluid, comprising contacting the fluid with a composition comprising:
   i) 1,2-dichloro-1,2-difluoroethylene; and
   ii) a compound selected from R-1336mzzZ, R-1336mzzE, R-1233xfB, R-1438mzzE, R-1438mzzZ, R-1224ydZ, R-1224ydE, R-1336yf, R-125, R-227ea, R-236fa, R-1225yeE, R-1225yeZ, 1,1,1,2,2,4,5,5,5-nonafluoro-4-(trifluoromethyl)pentan-3-one, water, carbon dioxide, nitrogen, and argon;

in a concentration sufficient to reduce the flammability of the fluid.
3. In some embodiments, the present application further provides a method of extinguishing or suppressing a fire, comprising:
   (a) providing a composition comprising:
      i) 1,2-dichloro-1,2-difluoroethylene; and
      ii) a compound selected from R-1336mzzZ, R-1336mzzE, R-1233xfB, R-1438mzzE, R-1438mzzZ, R-1224ydZ, R-1224ydE, R-1336yf, R-125, R-227ea, R-236fa, R-1225yeE, R-1225yeZ, 1,1,1,2,2,4,5,5,5-nonafluoro-4-(trifluoromethyl)pentan-3-one, water, carbon dioxide, nitrogen, and argon;
   (b) disposing the composition in a pressurized discharge system; and
   (c) discharging the composition into an area to extinguish or suppress the fire in that area.
4. The method of embodiment 3, wherein the method is a total flooding method.
5. The method of embodiment 3 or 4, wherein the method is a streaming method.
6. The method of any one of embodiments 3 to 5, wherein the area is an enclosed area.
7. The method of any one of embodiments 3 to 6, wherein after the discharging of step (c), the atmosphere within the enclosed area will not sustain or initiate combustion.
8. In some embodiments, the present application further provides a method of inerting an area to reduce or prevent occurrence of a fire, explosion, or combination thereof, in the area, the method comprising:
   (a) providing a composition comprising:
      i) 1,2-dichloro-1,2-difluoroethylene; and
      ii) a compound selected from R-1336mzzZ, R-1336mzzE, R-1233xfB, R-1438mzzE, R-1438mzzZ, R-1224ydZ, R-1224ydE, R-1336yf, R-125, R-227ea, R-236fa, R-1225yeE, R-1225yeZ, 1,1,1,2,2,4,5,5,5-nonafluoro-4-(trifluoromethyl)pentan-3-one, water, carbon dioxide, nitrogen, and argon;
   (b) disposing the composition in a pressurized discharge system; and
   (c) discharging the composition into the area to reduce or prevent the fire, explosion, or combination thereof from occurring.
9. The method embodiment 8, wherein the method is a total flooding method.
10. The method of embodiment 8 or 9, wherein the method is a streaming method.
11. The method of any one of embodiments 8 to 10, wherein the area is an enclosed area.
12. The method of any one of embodiments 8 to 11, wherein after the discharging of step (c), the atmosphere within the enclosed area will not sustain or initiate combustion.
13. The method of any one of embodiments 1 to 12, wherein the composition comprises 1,2-dichloro-1,2-difluoroethylene and R-1336mzzZ.
14. The method of any one of embodiments 1 to 12, wherein the composition comprises 1,2-dichloro-1,2-difluoroethylene and R-1233xfB.
15. The method of any one of embodiments 1 to 12, wherein the composition comprises 1,2-dichloro-1,2-difluoroethylene and R-1438mzzE.
16. The method of any one of embodiments 1 to 12, wherein the composition comprises 1,2-dichloro-1,2-difluoroethylene and R-1438mzzZ.
17. The method of any one of embodiments 1 to 12, wherein the composition comprises 1,2-dichloro-1,2-difluoroethylene and R-1336mzzE.
18. The method of any one of embodiments 1 to 12, wherein the composition comprises 1,2-dichloro-1,2-difluoroethylene and R-1224ydZ.
19. The method of any one of embodiments 1 to 12, wherein the composition comprises 1,2-dichloro-1,2-difluoroethylene and R-1224ydE.
20. The method of any one of embodiments 1 to 12, wherein the composition comprises 1,2-dichloro-1,2-difluoroethylene and R-1336yf.
21. The method of any one of embodiments 1 to 12, wherein the composition comprises 1,2-dichloro-1,2-difluoroethylene and R-125.
22. The method of any one of embodiments 1 to 12, wherein the composition comprises 1,2-dichloro-1,2-difluoroethylene and R-227ea.
23. The method of any one of embodiments 1 to 12, wherein the composition comprises 1,2-dichloro-1,2-difluoroethylene and 1,1,1,2,2,4,5,5,5-nonafluoro-4-(trifluoromethyl)pentan-3-one.
24. The method of any one of embodiments 1 to 12, wherein the composition comprises 1,2-dichloro-1,2-difluoroethylene and carbon dioxide.
25. The method of any one of embodiments 1 to 12, wherein the composition comprises 1,2-dichloro-1,2-difluoroethylene and water.
26. The method of any one of embodiments 1 to 12, wherein the composition comprises 1,2-dichloro-1,2-difluoroethylene and nitrogen.
27. The method of any one of embodiments 1 to 12, wherein the composition comprises 1,2-dichloro-1,2-difluoroethylene and argon.
28. The method of any one of embodiments 1 to 12, wherein the composition comprises 1,2-dichloro-1,2-difluoroethylene and R-236fa.
29. The method of any one of embodiments 1 to 12, wherein the composition comprises 1,2-dichloro-1,2-difluoroethylene and R-1225yeE.
30. The method of any one of embodiments 1 to 12, wherein the composition comprises 1,2-dichloro-1,2-difluoroethylene and R-1225yeZ.
31. In some embodiments, the present application further provides a fire suppression apparatus or system comprising a composition comprising:
   i) 1,2-dichloro-1,2-difluoroethylene; and
   ii) a compound selected from R-1336mzzZ, R-1336mzzE, R-1233xfB, R-1438mzzE, R-1438mzzZ, R-1224ydZ, R-1224ydE, R-1336yf, R-125, R-227ea, R-236fa, R-1225yeE, R-1225yeZ, 1,1,1,2,2,4,5,5,5-nonafluoro-4-(trifluoromethyl)pentan-3-one, water, carbon dioxide, nitrogen, and argon.
32. The fire suppression apparatus or system of embodiment 31, wherein the apparatus or system comprises:
   (a) a vessel containing a composition comprising:
      i) 1,2-dichloro-1,2-difluoroethylene; and
      ii) a compound selected from R-1336mzzZ, R-1336mzzE, R-1233xfB, R-1438mzzE, R-1438mzzZ, R-1224ydZ, R-1224ydE, R-1336yf, R-125, R-227ea, R-236fa, R-1225yeE, R-1225yeZ, 1,1,1,2,2,4,5,5,5-nonafluoro-4-(trifluoromethyl)pentan-3-one, water, carbon dioxide, nitrogen, and argon; and
   (b) a nozzle to dispense said composition.
33. The fire suppression apparatus or system of embodiment 31 or 32, wherein the composition comprises 1,2-dichloro-1,2-difluoroethylene and R-1336mzzZ.
34. The fire suppression apparatus or system of embodiment 31 or 32, wherein the composition comprises 1,2-dichloro-1,2-difluoroethylene and R-1233xfB.
35. The fire suppression apparatus or system of embodiment 31 or 32, wherein the composition comprises 1,2-dichloro-1,2-difluoroethylene and R-1438mzzE.
36. The fire suppression apparatus or system of embodiment 31 or 32, wherein the composition comprises 1,2-dichloro-1,2-difluoroethylene and R-1438mzzZ.
37. The fire suppression apparatus or system of embodiment 31 or 32, wherein the composition comprises 1,2-dichloro-1,2-difluoroethylene and R-1336mzzE.
38. The fire suppression apparatus or system of embodiment 31 or 32, wherein the composition comprises 1,2-dichloro-1,2-difluoroethylene and R-1224ydZ.
39. The fire suppression apparatus or system of embodiment 31 or 32, wherein the composition comprises 1,2-dichloro-1,2-difluoroethylene and R-1224ydE.
40. The fire suppression apparatus or system of embodiment 31 or 32, wherein the composition comprises 1,2-dichloro-1,2-difluoroethylene and R-1336yf.
41. The fire suppression apparatus or system of embodiment 31 or 32, wherein the composition comprises 1,2-dichloro-1,2-difluoroethylene and R-125.
42. The fire suppression apparatus or system of embodiment 31 or 32, wherein the composition comprises 1,2-dichloro-1,2-difluoroethylene and R-227ea.
43. The fire suppression apparatus or system of embodiment 31 or 32, wherein the composition comprises 1,2-dichloro-1,2-difluoroethylene and 1,1,1,2,2,4,5,5,5-nonafluoro-4-(trifluoromethyl)pentan-3-one.
44. The fire suppression apparatus or system of embodiment 31 or 32, wherein the composition comprises 1,2-dichloro-1,2-difluoroethylene and carbon dioxide.
45. The fire suppression apparatus or system of embodiment 31 or 32, wherein the composition comprises 1,2-dichloro-1,2-difluoroethylene and water.
46. The fire suppression apparatus or system of embodiment 31 or 32, wherein the composition comprises 1,2-dichloro-1,2-difluoroethylene and nitrogen.
47. The fire suppression apparatus or system of embodiment 31 or 32, wherein the composition comprises 1,2-dichloro-1,2-difluoroethylene and argon.
48. The fire suppression apparatus or system of embodiment 31 or 32, wherein the composition comprises 1,2-dichloro-1,2-difluoroethylene and R-236fa.
49. The fire suppression apparatus or system of embodiment 31 or 32, wherein the composition comprises 1,2-dichloro-1,2-difluoroethylene and R-1225yeE.
50. The fire suppression apparatus or system of embodiment 31 or 32, wherein the composition comprises 1,2-dichloro-1,2-difluoroethylene and R-1225yeZ.
51. In some embodiments, the present application provides a composition, comprising:
   i) 1,2-dichloro-1,2-difluoroethylene; and
   ii) a compound selected from R-1233xfB, R-1438mzzE, R-227ea, R-236fa, R-1225yeE, 1,1,1,2,2,4,5,5,5-nonafluoro-4-(trifluoromethyl)pentan-3-one, carbon dioxide, nitrogen, and argon.
52. The method of any one of embodiments 1 to 12, wherein the composition comprises:
   i) 1,2-dichloro-1,2-difluoroethylene; and
   ii) a compound selected from R-1233xfB, R-1438mzzE, R-227ea, R-236fa, R-1225yeE, 1,1,1,2,2,4,5,5,5-nonafluoro-4-(trifluoromethyl)pentan-3-one, carbon dioxide, nitrogen, and argon.
53. The fire suppression apparatus or system of embodiment 31 or 32, wherein the composition comprises:
   i) 1,2-dichloro-1,2-difluoroethylene; and
   ii) a compound selected from R-1233xfB, R-1438mzzE, R-227ea, R-236fa, R-1225yeE, 1,1,1,2,2,4,5,5,5-nonafluoro-4-(trifluoromethyl)pentan-3-one, carbon dioxide, nitrogen, and argon.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims. It should be appreciated by those persons having ordinary skill in the art(s) to which the present invention relates that any of the features described herein in respect of any particular aspect and/or embodiment of the present invention can be combined with one or more of any of the other features of any other aspects and/or embodiments of the present invention described herein, with modifications as appropriate to ensure compatibility of the combinations. Such combinations are considered to be part of the present invention contemplated by this disclosure.

1. A process for extinguishing or suppressing a flame, comprising dispensing at the flame a composition comprising:
i) 1,2-dichloro-1,2-difluoroethylene; and
ii) a compound selected from R-1336mzzZ, R-1336mzzE, R-1233xfB, R-1438mzzE, R-1438mzzZ, R-1224ydZ, R-1224ydE, R-1336yf, R-125, R-227ea, R-236fa, R-1225yeE, R-1225yeZ, 1,1,1,2,2,4,5,5,5-nonafluoro-4-(trifluoromethyl)pentan-3-one, water, carbon dioxide, nitrogen, and argon;
in a concentration sufficient to extinguish or suppress the flame.

2-19. (canceled)

20. A method of reducing the flammability of a fluid, comprising contacting the fluid with a composition comprising:
i) 1,2-dichloro-1,2-difluoroethylene; and
ii) a compound selected from R-1336mzzZ, R-1336mzzE, R-1233xfB, R-1438mzzE, R-1438mzzZ, R-1224ydZ, R-1224ydE, R-1336yf, R-125, R-227ea, R-236fa, R-1225yeE, R-1225yeZ, 1,1,1,2,2,4,5,5,5-nonafluoro-4-(trifluoromethyl)pentan-3-one, water, carbon dioxide, nitrogen, and argon;
in a concentration sufficient to reduce the flammability of the fluid.

21. A method of extinguishing or suppressing a fire, comprising:
(a) providing a composition comprising:
i) 1,2-dichloro-1,2-difluoroethylene; and
ii) a compound selected from R-1336mzzZ, R-1336mzzE, R-1233xfB, R-1438mzzE, R-1438mzzZ, R-1224ydZ, R-1224ydE, R-1336yf, R-125, R-227ea, R-236fa, R-1225yeE, R-1225yeZ, 1,1,1,2,2,4,5,5,5-nonafluoro-4-(trifluoromethyl)pentan-3-one, water, carbon dioxide, nitrogen, and argon;
(b) disposing the composition in a pressurized discharge system; and
(c) discharging the composition into an area to extinguish or suppress the fire in that area.

22. The method of claim 21, wherein the method is a total flooding method.

23. The method of claim 21, wherein the method is a streaming method.

24. The method of claim 21, wherein the area is an enclosed area.

25. The method of claim 24, wherein after the discharging of step (c), the atmosphere within the enclosed area will not sustain or initiate combustion.

26. A method of inerting an area to reduce or prevent occurrence of a fire, explosion, or combination thereof, in the area, the method comprising:
(a) providing a composition comprising:
i) 1,2-dichloro-1,2-difluoroethylene; and
ii) a compound selected from R-1336mzzZ, R-1336mzzE, R-1233xfB, R-1438mzzE, R-1438mzzZ, R-1224ydZ, R-1224ydE, R-1336yf, R-125, R-227ea, R-236fa, R-1225yeE, R-1225yeZ, 1,1,1,2,2,4,5,5,5-nonafluoro-4-(trifluoromethyl)pentan-3-one, water, carbon dioxide, nitrogen, and argon;
(b) disposing the composition in a pressurized discharge system; and
(c) discharging the composition into the area to reduce or prevent the fire, explosion, or combination thereof from occurring.

27. The method of claim 26, wherein the method is a total flooding method.

28. The method of claim 26, wherein the method is a streaming method.

29. The method of claim 26, wherein the area is an enclosed area.

30. The method of claim 29, wherein after the discharging of step (c), the atmosphere within the enclosed area will not sustain or initiate combustion.

31. A fire suppression apparatus or system comprising a composition comprising:
i) 1,2-dichloro-1,2-difluoroethylene; and
ii) a compound selected from R-1336mzzZ, R-1336mzzE, R-1233xfB, R-1438mzzE, R-1438mzzZ, R-1224ydZ, R-1224ydE, R-1336yf, R-125, R-227ea, R-236fa, R-1225yeE, R-1225yeZ, 1,1,1,2,2,4,5,5,5-nonafluoro-4-(trifluoromethyl)pentan-3-one, water, carbon dioxide, nitrogen, and argon.

32. The fire suppression apparatus or system of claim 28, wherein the apparatus or system comprises:
(a) a vessel containing a composition comprising:
i) 1,2-dichloro-1,2-difluoroethylene; and
ii) a compound selected from R-1336mzzZ, R-1336mzzE, R-1233xfB, R-1438mzzE, R-1438mzzZ, R-1224ydZ, R-1224ydE, R-1336yf, R-125, R-227ea, R-236fa, R-1225yeE, R-1225yeZ, 1,1,1,2,2,4,5,5,5-nonafluoro-4-(trifluoromethyl)pentan-3-one, water, carbon dioxide, nitrogen, and argon;
and
(b) a nozzle to dispense said composition.

33. A composition, comprising:
i) 1,2-dichloro-1,2-difluoroethylene; and
ii) a compound selected from R-1233xfB, R-1438mzzE, R-227ea, R-236fa, R-1225yeE, 1,1,1,2,2,4,5,5,5-nonafluoro-4-(trifluoromethyl)pentan-3-one, carbon dioxide, nitrogen, and argon.
